(19) United States
(12) Patent Application Publication
(10) Pub. No.: US 2025/0221874 A1
(43) Pub. Date: Jul. 10, 2025

(54) URN CARRIER FOR A FUNERAL VEHICLE, FUNERAL VEHICLE HAVING SUCH AN URN CARRIER, AND RELATED METHOD

(71) Applicant: FederalEagle, LLC, West Chester, OH (US)

(72) Inventors: Donald A. Reaves, West Chester, OH (US); Matthew Hosterman, Lebanon, OH (US); Stephen Bentley, Cincinnati, OH (US)

(73) Assignee: FederalEagle, LLC, West Chester, OH (US)

(21) Appl. No.: 19/010,347

(22) Filed: Jan. 6, 2025

Related U.S. Application Data
(60) Provisional application No. 63/709,556, filed on Oct. 21, 2024.
(60) Provisional application No. 63/619,090, filed on Jan. 9, 2024.

(51) Int. Cl. A61G 21/00

(52) U.S. Cl. CPC A61G 21/00

(57) ABSTRACT

An urn carrier for a funeral vehicle having a casket compartment is disclosed. The urn carrier includes an urn support that is configured to receive at least one urn, and a movement element that is configured to removably receive the urn support. The movement element is configured to move the urn support along a length of the casket compartment between various positions including a stowed position and a ceremonial position. A funeral vehicle having such an urn carrier and a method of handling an urn in a funeral vehicle are also disclosed.

### TECHNICAL FIELD

The present invention relates generally to funeral services, and relates, more specifically, to means and an apparatus for transporting cremated remains.

### BACKGROUND

Humans have provided various ceremonies for family members and loved ones that have passed since ancient times. While various rituals, practices, and methods of internment are used around the world, many rely on the use of burial in a casket. Traditional funeral homes already have the facilities, equipment, and training to conduct memorial services and disposition ceremonies for casketed burials. For example, the transportation of caskets in various vehicles are well known by funeral homes and society in general. Hearses, for example, are designed to transport caskets during burial ceremonies, such as from the funeral home or place or worship to the burial site, in a functional, aesthetic, and respectful manner. While casketed burial services remain popular, over the past few decades, families have been open to considering alternatives to the traditional funeral ceremonies for after death services. In this regard, cremation services have grown significantly in recent years.

As a result of the increase in cremations, funeral directors have tried to bridge the connection between traditional funeral services, with which they are familiar and well versed, and the growing number of people who are making non-traditional choices. Bridging this connection, however, remains a challenge. For example, solutions for incorporating a decedent's cremated remains into traditional funeral services are lacking, especially with respect to the transport of the cremated remains during the ceremony. While hearses are typically used to transport caskets, such funeral vehicles are generally not chosen by families for transporting cremated remains during burial ceremonies. Manufacturers of funeral vehicles have previously attempted to develop various features to enable an urn with cremated remains to be displayed and secured in the casket compartment of a hearse. However, usage rates of hearses or other funeral vehicles having such features have remained relatively low.

Accordingly, there remains a need within the funeral industry to provide an appealing and respectful solution for transporting cremated remains in a funeral vehicle.

### SUMMARY

According to one aspect of the invention, an urn carrier for a funeral vehicle having a casket compartment is disclosed. The urn carrier includes an urn support that is configured to receive at least one urn and a movement element that is configured to removably receive the urn support. The movement element is configured to move the urn support along a length of the casket compartment. The urn carrier is configured to provide a secure, aesthetically pleasing, and respectful manner of transporting cremated remains in the at least one urn using the funeral vehicle. The urn carrier is further configured to provide funeral directors and other burial service providers the option of transporting either a casket or a cremation urn within the same funeral vehicle. Thus, the same funeral vehicle may be used to provide traditional funeral ceremonies utilizing a casket and non-traditional funeral ceremonies having cremated remains.

In one embodiment, the movement element, and thus the urn support mounted thereon, may be movable between at least a stowed position and a ceremonial position. For example, in one embodiment, the urn support may be moveable between the stowed position, a transport position, the ceremonial position, and an extended position within the casket compartment of the funeral vehicle. In one embodiment, when the urn support is in the stowed position, the funeral vehicle may be configured to receive a casket within the casket compartment of the funeral vehicle. In other words, in the stowed position, the urn carrier may be out of the way and a casket may fit within the casket compartment of the funeral vehicle without interference. In one embodiment, when the urn support is in the transport position, the urn support may be located in a front region of the casket compartment. In one embodiment, when the urn support is in the ceremonial position, the urn support may be located in a rear region of the casket compartment. For example, in one embodiment, when the urn carrier is in the ceremonial position, the urn support may be located adjacent a load door of the funeral vehicle. In one embodiment, when the urn support is in the extended position, a portion of the urn support may extend from a load door opening of the funeral vehicle. This allows, for example, the urn support to be easily and conveniently removed from the funeral vehicle.

In one embodiment, the urn carrier may include a sled that is operatively supported within the casket compartment of the funeral vehicle by the movement element and the urn support may be removably attachable to the sled. In one embodiment, for example, the movement element may be operatively connected to or form part of at least one drive mechanism for moving the urn support between its various positions. In one embodiment, the at least one drive mechanism may include a linear drive having a drive member and the urn support may be removably attachable to the drive member. In one embodiment, the linear drive may be located beneath a floor of the casket compartment. In this regard, the floor of the casket compartment may include a track slot through which the drive member is configured to extend and along which the drive member is configured to travel. In one embodiment, the track slot may extend from the front region of the casket compartment to the rear region of the casket compartment so as to position the urn support in its various positions. In an alternative embodiment, the urn support may not be driven between its various position; but instead, the urn support may be manually moved between its various positions within the casket compartment of the funeral vehicle.

In one embodiment, the at least one drive mechanism is configured to rotate the urn support as the urn support is moved between at least the stowed position and the ceremonial position. For example, in one embodiment, the drive member may be configured to rotate relative to the linear drive so as to rotate the urn support. In one embodiment, the urn support may be configured to rotate about 90° during movement from the stowed position to the ceremonial position. In this embodiment, a longitudinal axis of the urn support may be substantially perpendicular to a longitudinal axis of the casket compartment when the urn support is in the stowed position, and the longitudinal axis of the urn support may be substantially parallel to the longitudinal axis of the casket compartment when the urn support is in the ceremonial position. In another embodiment, however, the urn support may not rotate; but instead, the urn support may have a fixed orientation as it moves between the various positions.

According to another aspect of the invention, a funeral vehicle including the urn carrier according to the first aspect described above is disclosed. In one embodiment, the funeral vehicle may include a movable partition within the casket compartment that is movable between a retracted position and a deployed position. In one embodiment, the movable partition may be in the retracted position when the urn support is in the stowed position and the movable partition may be in the deployed position when the urn carrier is in the ceremonial position. Thus, for example, the movable partition may separate a front region of the casket compartment of the funeral vehicle from a rear region of the casket compartment of the funeral vehicle when in the deployed position. Additionally, in one embodiment, movement of the urn support from the stowed position to the ceremonial position may correspond to (e.g., be in coordination with) movement of the movable partition from the retracted position to the deployed position. In other words, in one embodiment, the movable partition may be configured to move between the stowed the retracted and deployed positions in an automated way depending on the position of the urn support within the casket compartment of the funeral vehicle. The moveable partition may include various decorative and/or symbolic features to provide an aesthetic aspect of the partition. The movable partition may also prevent family members are the rear of the funeral vehicle from viewing the portion of the casket compartment beyond the partition.

In one embodiment, the movable partition may be attached to a headliner of the funeral vehicle. In that regard, the movable partition may be adjacent to the headliner (e.g., be within or form part of the headliner) when in the retracted position. In one embodiment, the movable partition may be formed of a plurality of panels that are movable between a folded configuration when the movable partition is in the stowed position and an unfolded configuration when the movable partition is in the deployed position. In that regard, the plurality of panels may be configured to unfold to form the partition as the movable partition moves from the retracted position to the stowed position.

In one embodiment, when the urn support is in the transport position, the urn support may be located in a front region of the funeral vehicle and spaced from the moveable partition. In one embodiment, the funeral vehicle may include a storage compartment located in a cargo space of the funeral vehicle that is configured to receive the urn support when not in use, such as when the urn support is in the stowed position.

In yet another aspect of the invention, a method of handling an urn in a funeral vehicle having a casket compartment is disclosed. The method includes providing an urn carrier. The urn carrier includes an urn support configured to receive at least one urn, and a movement element configured to removably receive the urn support. The movement element is configured to move the urn support along a length of the casket compartment. The method further includes moving the urn support from a first position within the casket compartment to a second position within the casket compartment.

In one embodiment, moving the urn carrier from the first position to the second position may include driving the movement of the urn carrier with at least one drive mechanism. In an alternative embodiment, moving the urn carrier from the first position to the second position may include manually moving the urn carrier. In one embodiment, the method may further include rotating the urn support in the movement between the first position and the second position. In an alternative embodiment, however, the urn support may not be rotated in the movement between the first position and the second position.

In one embodiment, the casket compartment of the funeral vehicle may include a movable partition, and the method further include moving the movable partition from a retracted position to a deployed position in the movement between the first position and the second position. In one embodiment, the method may further include moving the urn support from the second position the first position and moving the movable partition from the deployed position to the retracted position in the movement between the first position and the second position. In an exemplary embodiment, the first position may be the stowed position, or the transport position and the second position may be the ceremonial position.

Additional features and advantages will be set forth in the detailed description which follows, and in part will be readily apparent to those skilled in the art. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings, which are incorporated in and constitute a part of this specification, illustrate embodiments of the invention and, together with the Detailed Description given below, serve to explain the invention.

FIG. 1 is an environmental, side view of a casket compartment of a funeral vehicle, illustrating an urn carrier in accordance with principles of the present invention.

FIG. 2 is a perspective view of the casket compartment of the funeral vehicle and urn carrier of FIG. 1.

FIG. 3 is a perspective view of a drive mechanism of the urn carrier in accordance with an embodiment of the invention.

FIG. 4 is an underside view of a floor of the casket compartment of the funeral vehicle, illustrating additional details of the drive mechanism of FIG. 3.

FIGS. 5A-5D are perspective views illustrating movement of a sled and urn support of the urn carrier within the casket compartment of the funeral vehicle.

FIG. 6 is a top view of the funeral vehicle illustrating the sled and the urn support of the urn carrier in an extended position.

FIG. 7 is side view of the funeral vehicle when the sled and the urn support of the urn carrier are in the extended position.

FIG. 8 is a side view of the funeral vehicle with a load door of the funeral vehicle open, illustrating a movable partition in a deployed position in accordance with an embodiment of the invention.

FIGS. 9A-9C are perspective views illustrating movement of the moveable partition from a retracted position to a deployed position.

### DETAILED DESCRIPTION

The exemplary embodiments described herein are provided for illustrative purposes and are not limiting. Other exemplary embodiments are possible, and modifications may be made to the exemplary embodiments within the scope of the present disclosure. Therefore, this Detailed Description is not meant to limit the scope of the present disclosure.

As described above, solutions for respectfully incorporating a decedent's cremated remains into traditional funeral services are lacking. Various aspects of the present invention address this issue by providing an urn carrier for respectfully, and in an appealing manner, displaying and transporting an urn in a funeral vehicle. The funeral vehicle may be a hearse, for example, that is typically used for casketed funeral services. In that regard, the funeral vehicle may include a casket compartment for carrying a casket. The urn carrier provides the ability to use the hearse for cremation services in addition to its use for casketed services. Thus, the urn carrier provides the funeral vehicle with dual functionality, allowing the funeral vehicle to be used for both casketed and cremation services. To that end, the urn carrier is configured to be located in the casket compartment of the funeral vehicle and includes a movable sled and an urn support that provides a display to present the urn, along with other commemorative display visuals, to the decedent's family during the memorial service, for example.

The urn carrier, and more particularly the sled of the urn carrier is movable within the casket compartment of the funeral vehicle between at least a stowed position, a transport position, and a ceremonial position. In that regard, when the funeral vehicle is not being used for a cremation service, the urn carrier may be moved to the stowed position. When in the stowed position, the sled and the urn support of the urn carrier are stored out of the way so that a casket may be received within the casket compartment of the funeral vehicle for a casketed funeral service. When the funeral vehicle is being used for a cremation service, the urn carrier may be moved from the stowed position to a transport position, and later to a ceremonial position to present the urn support (and urn) for the cremation service. The urn carrier may be further moved from the ceremonial position to an extended position, which facilitates removal of the urn support from the funeral vehicle.

In addition to the above, the funeral vehicle may include other features to improve the display of the urn during the cremation service. For example, the funeral vehicle may include a movable partition that is configured to be deployed within the casket compartment, particularly when the urn carrier is in the transport and/or the ceremonial position. When deployed, the movable partition may be located behind the urn carrier when viewed from a load door opening of the funeral vehicle. To this end, the movable partition may be decorated with scenes or religious symbols, for example. These and other advantages and technical effects of the embodiments of this invention will become evident to one skilled in the art from the following description.

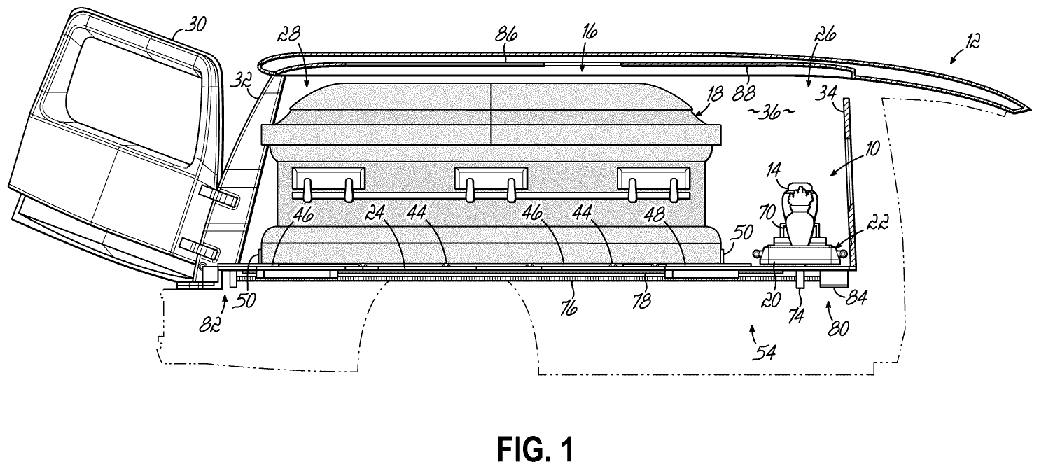

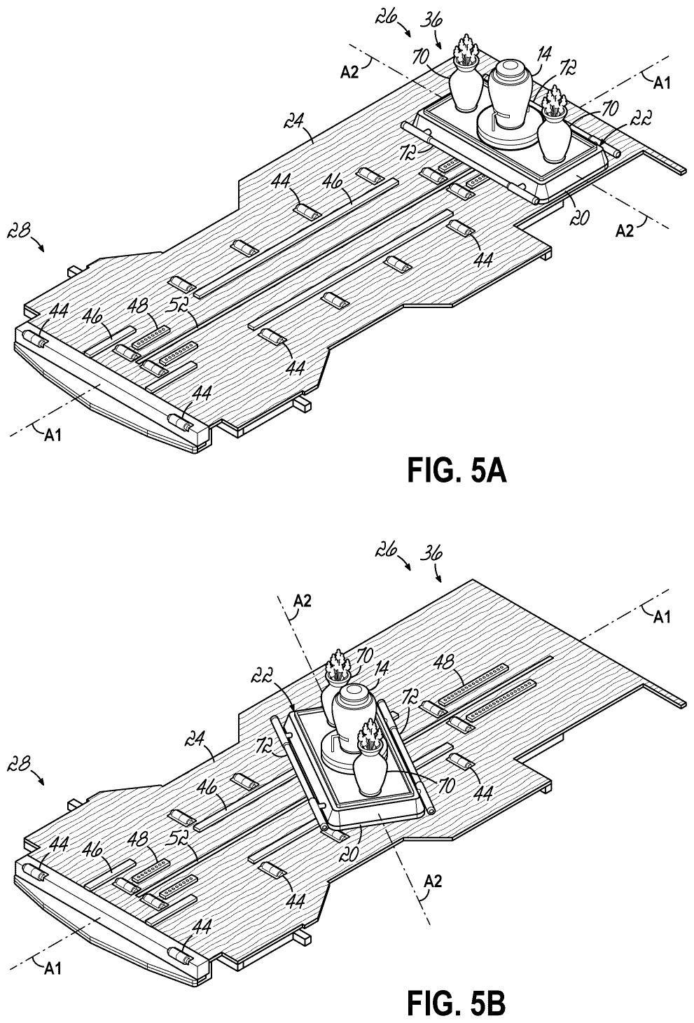

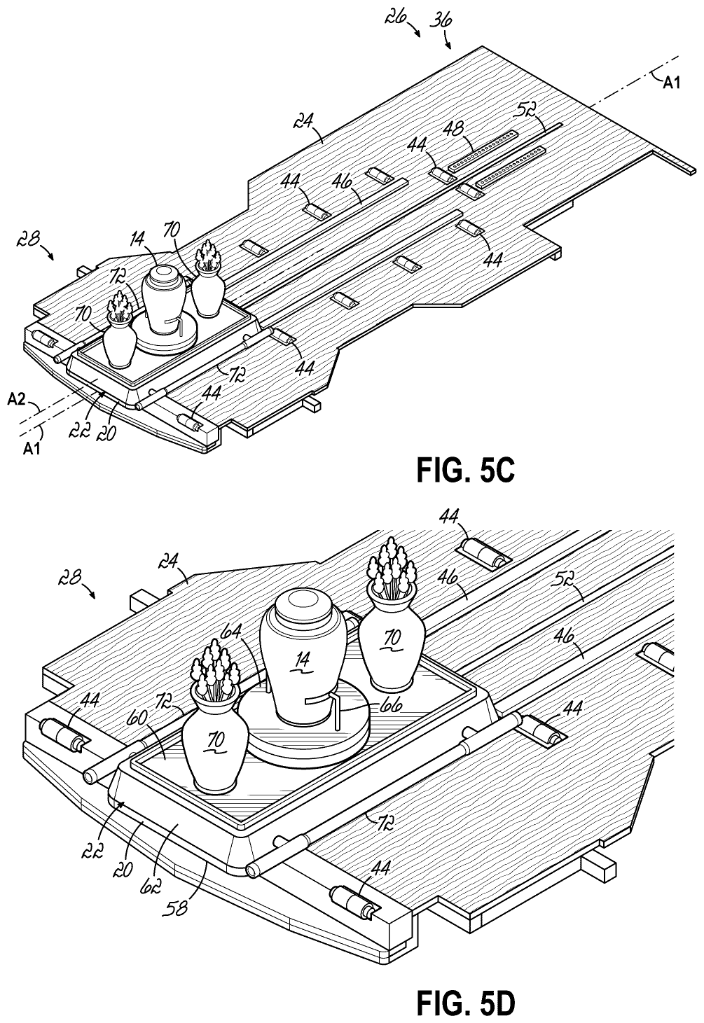

Referring now to the figures, embodiments of an urn carrier 10 for use in a funeral vehicle 12 (e.g., a hearse) in accordance with principles of the present invention are shown. Referring now to FIG. 1, the figure shows an embodiment of the urn carrier 10, with an urn 14 located thereon. As shown, the urn carrier 10 is configured to be located in a casket compartment 16 of the funeral vehicle 12 where a casket 18 may typically reside, such as when the funeral vehicle 12 is being used for a casketed funeral service. The urn carrier 10 includes a sled 20 and a removable urn support 22 that is configured to be supported by the sled 20. The sled 20 is configured to move along a base floor 24 of the casket compartment 16 of the funeral vehicle 12. In the embodiment shown, the sled 20 is configured to move along a length of the casket compartment 16, such as between a front region 26 of the casket compartment 16 and a rear region 28 of the casket compartment 16. Stated another way, the sled 20 is configured to move in a direction along a longitudinal axis A1 of the casket compartment 16 (e.g., FIGS. 5A-5C). The urn support 22 is removably supported on the sled 20 and is configured to receive and display the urn 14. As will be described in further detail below, the sled 20 is selectively operable to move the urn support 22 within the casket compartment 16 from at least a stowed position, as shown in FIG. 1, to a ceremonial position. More particularly, in one embodiment, the sled 20 is selectively operable to move the urn support 22 within the casket compartment 16 from the stowed position to a transport position, and then to a ceremonial position (and possibly an extended position).

The casket compartment 16 of the funeral vehicle 12 is accessible via a load door 30 that provides access to a load door opening 32 to the casket compartment 16. The casket compartment 16 extends from the rear region 28 where the load door 30 of the funeral vehicle 12 is located to the front region 26 that is adjacent a partition 34 that separates at least the driver compartment of the funeral vehicle 12 from the casket compartment 16. The length of the casket compartment 16 is larger than the largest casket 18 size to provide a cargo space 36 in the front region 26 of the casket compartment 16. However, in an alternative embodiment, the casket compartment 16 may be sized such that the cargo space 36 is smaller or larger. In one embodiment, there may not be a cargo space 36. In the embodiment shown, the sled 20 and the urn support 22 of the urn carrier 10 are configured to be stored within the cargo space 36 when not in use. This positioning of the sled 20 and the urn support 22 is referred to as the stowed position. To that end, the sled 20 and the urn support 22 may reside in the cargo space 36 of the casket compartment 16 when not needed, such as when the funeral vehicle 12 is being used to transport the casket 18 for a casketed funeral service. The cargo space 36 may be large enough to store other funeral related items in addition to components associated with the urn carrier 10, such as chairs, tables, decorations, etc. In an alternative embodiment, when not needed, such as when the funeral vehicle 12 is being used for a casketed service, at least the urn support 22 may be removed from the funeral vehicle 12.

To hide the sled 20 and the urn support 22 from sight, as well as protect the sled 20 and the urn support 22 when not in use, the urn carrier 10 may further include a removable cover (not shown). The cover may be decorative, incorporating ornamental features or designs, for example, to enhance the aesthetic appeal of the casket compartment 16. The cover is configured to cover parts of the urn carrier 10, such as the sled 20 and the urn support 22, to prevent damage to those parts from the storage of other items in the cargo space 36. The cover may be completely removable or operatively attached to a part of the funeral vehicle 12. For example, the cover may be attached, permanently (i.e., via a hinge) or temporarily (i.e., via clips or latches), to the partition 34. In one embodiment, the cover may be a permanent fixture in the funeral vehicle 12 to define a storage compartment (e.g., garage) for the sled 20 and the urn support 22. In this configuration, the cover may include a panel or door (e.g., garage door) that is openable, either manually or automatically, to provide access to the storage compartment, allowing the sled 20 and the urn support 22 to be moved into the storage compartment for storage or removed for use. Regardless, the cover may include at least a flat top surface on which additional items may be stored. For example, the top surface of the cover may include one or more indents or depressions to receive flower vases or other funeral related items. The cover may be made of the same material as the floor 24 of the casket compartment 16, for example. In an alternative embodiment, the urn carrier 10 may not include a cover.

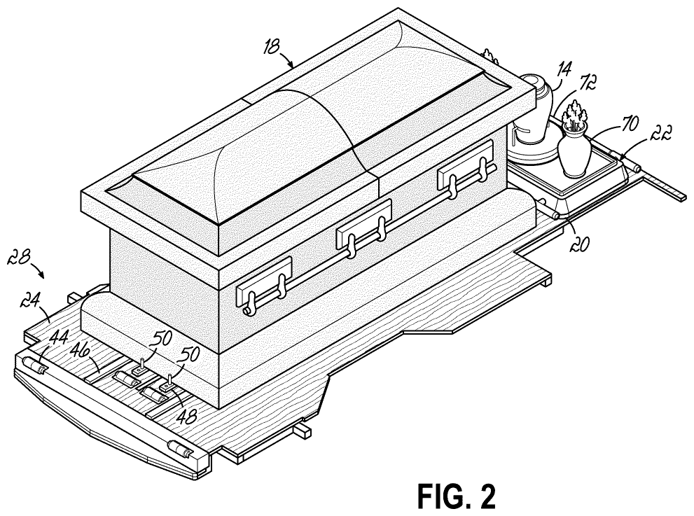

Referring now to FIGS. 2 and 5A-5D, the casket compartment 16 of the funeral vehicle 12 includes certain components to facilitate receival and removal of the casket 18 from the casket compartment 16. Certain of the components may also be used to facilitate movement of the urn carrier 10. For example, the floor 24 of the casket compartment 16 may include one or more of the following: rollers 44, skid bars 46, bier pin plates 48 and associated bier pins 50. The rollers 44 and the skid bars 46 facilitate sliding the casket 18 into or out from the casket compartment 16. The bier pin plates 48 and associated bier pins 50 are used to secure the casket 18 in place to the floor 24 of the casket compartment 16 for transport by the funeral vehicle 12, as will be understood by a person of ordinary skill in the art. As shown, the floor 24 of the casket compartment 16 further includes a track slot 52 along which the sled 20 and the urn support 22 of the urn carrier 10 are configured to travel, as will be described in further detail below. In the embodiment shown, the track slot 52 is centrally located on the floor 24 of the casket compartment 16; however, the track slot 52 may be located elsewhere. In either case, the track slot 52 may extend from the front region 26 of the casket compartment 16 to the rear region 28 of the casket compartment 16.

With continued reference to FIGS. 2 and 5A-5D, additional details of the urn carrier 10 will now be described. As briefly described above, the urn carrier 10 includes the sled 20 that is configured to removably receive the urn support 22. In that regard, the sled 20 is movable in a direction along the length of the casket compartment 16 and between at least the stowed position, a transport position, and a ceremonial position. The urn support 22 is configured to be removably attached to the sled 20 and as such is movable along the length of the casket compartment 16 with the sled 20. The urn carrier 10 further includes at least one movement element that is configured to move the urn support 22 along a length of the casket compartment 16. The movement element may be any device that permits manual or driven movement of the urn support 22 along the length of the casket compartment 16 of the funeral vehicle 12. For example, the movement element may comprise a slide track, pulley system, chain and sprocket system, rail system, or a driven system as described in further detail below.

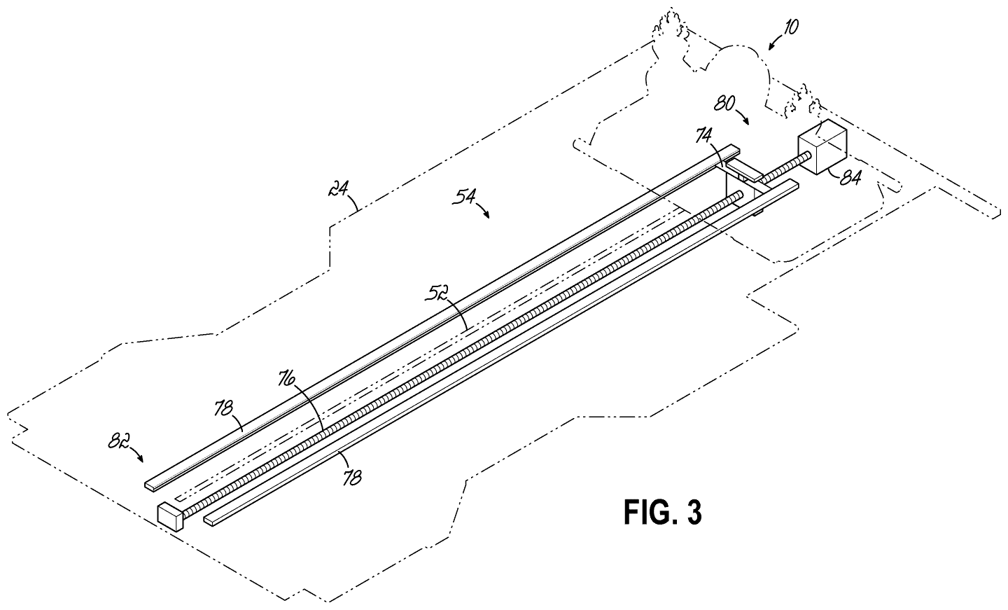

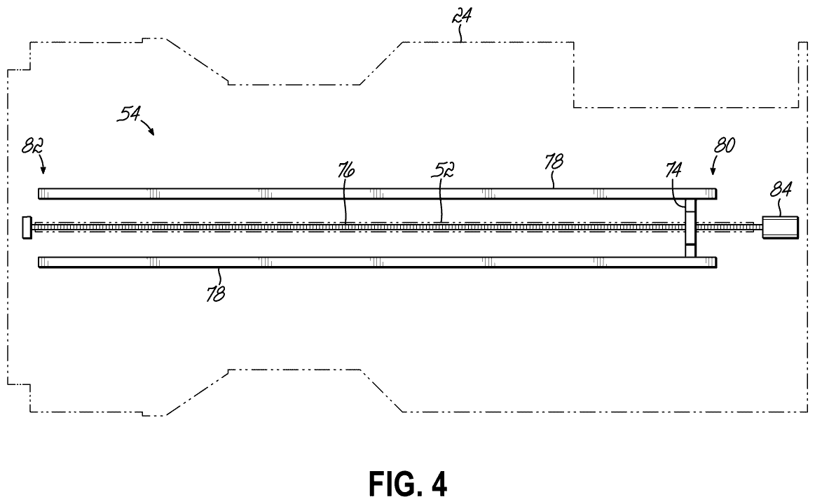

In the exemplary embodiment illustrated in FIGS. 3 and 4, the movement element is operatively coupled to or may form part of a drive mechanism 54 that is configured to drive movement of the sled 20 and the urn support 22 mounted thereon. The drive mechanism 54 is supported by the funeral vehicle 12, and in the embodiment shown, is located beneath the floor 24 of the casket compartment 16. In that regard, the sled 20 is operatively coupled to the drive mechanism 54 via a drive member that extends through the track slot 52 in the floor 24 and into engagement with the sled 20. The drive member may comprise a drive shaft 76 in the form of a rod or bar, for example. To that end, the drive member travels along the track slot 52 as the sled 20 and the urn support 22 are moved by the drive mechanism 54. As will be described in further detail below, the drive mechanism 54 may be configured to impart at least one of linear and rotational movement to the sled 20 and the urn support 22.

The sled 20 may comprise a plate, such as a metal, wood, or plastic plate, that is movably supported above the floor 24 of the casket compartment 16 by the drive member of the drive mechanism 54. The sled 20 is configured to receive the urn support 22 and may have a footprint that is smaller, the same size, or larger than a footprint of the urn support 22. The sled 20 is configured to removably receive the urn support 22 and may include one or more clips, latches, pins, straps, magnets, electromagnets, or other suitable mechanical or electronic fastener(s) to temporarily secure the urn support 22 to the sled 20. Further, as the sled 20 is moved along the floor 24 of the casket compartment 16 by the drive mechanism 54, the sled 20 may be configured to engage one or more of the rollers 44, skid bars 46, and/or bier pin plates 48, for example, that are located on the floor 24 of the casket compartment 16. Alternatively, the sled 20 may be spaced above so as to not engage any part of the floor 24 of the casket compartment 16 as the sled 20 is moved along the floor 24 by the drive mechanism 54.

The urn support 22 is configured to be removably positioned atop the sled 20 and provides a display to present the urn 14. The urn support 22 may include one or more mechanical or electronic fasteners that correspond to those located on the sled 20 to temporarily secure the urn support 22 to the sled 20. As best shown in FIG. 5D, the urn support 22 includes a base 58, an opposite top 60, and sidewalls 62. The urn support 22 is elongate along a longitudinal axis A2 of the urn support 22 (e.g., FIG. 5A). The top 60 of the urn support 22 defines a platform on which the urn 14 is configured to be located. The base 58 of the urn support 22 is configured to engage the sled 20, as shown. Additionally, the base 58 may include features that facilitate the support of the urn support 22 on other items, such as funeral carts, church trucks, etc. For example, the base 58 may include one or more detents that help support the urn support on other transport devices. The detents may include inwardly directed recesses, for example, configured to receive posts or projections on the transport devices. Alternatively, the detents may include outwardly directed projections configured to be received in recesses or openings on the transport device. The urn support 22 may be formed of a sturdy material, such as wood, metal, or plastic, and is designed to provide a stable foundation for supporting and carrying the urn 14. The top 60 of the urn support 22 may include at least one urn cradle 64 for receiving the urn 14 and one or more locking mechanisms 66, such as adjustable locking arms, for preventing unwanted movement of the urn 14 relative to the urn support 22. The urn support 22 may include certain other decorative features, and the drawings are not intended to be limiting in that regard. For example, the top 60 of the urn support 22 may include one or more depressions, stands, mounts, or other component(s) to receive one or more flower arrangements 70, for example. To that end, it will be understood that the urn support 22 may include commemorative display visuals to the decedent's family, and/or be decorated with scenes or religious symbols, a drape, or other suitable display elements.

With continued reference to FIG. 5D, the urn support 22 may include one or more handles 72 to facilitate lifting the urn support 22 from the sled 20 for removal from the funeral vehicle 12 and for placing the urn support 22 back onto the sled 20. As shown, the handles 72 may be located on the sidewalls 62 of the urn support 22. In particular, the handles 72 are in the form of poles mounted to opposite longitudinally extending sidewalls 62 of the urn support 22. That is, the handles 72 may extend generally parallel to the longitudinal axis A1 of the urn support 22 (e.g., FIG. 5A). While the handles 72 are shown as being in the form of poles, it will be understood that other handle 72 configurations are possible. For example, the handles 72 may be permanently attached to or removable from the urn support 22. In one embodiment, the handles 72 may be retractable. One or more of the sidewalls 62 of the urn support 22 may include one or more handles 72. To that end, the handles 72 may comprise any configuration capable of being gripped by one or more persons (e.g., pallbearers) to carry the urn support 22. The configuration of the urn support 22 is exemplary, and it will be understood that the urn support 22 may be larger, smaller, shaped differently, and/or include fewer or more handles 72, otherwise referred to as pall bearers, than what is shown, for example.

Referring to FIGS. 3 and 4, additional details of the drive mechanism 54 are shown and will now be described. In the embodiment shown, the drive mechanism 54 is a linear drive, such as linear slide drive. In particular, the drive mechanism 54 includes a slide 74 that is operatively connected to a drive shaft 76 and a pair of guide bars 78 that may support the drive mechanism 54 from part of the funeral vehicle 12, such as the floor 24, for example. The drive shaft 76 and the guide bars 78 each extend from a first end 80 to a second end 82 of the drive mechanism 54 to define a working length of the drive mechanism 54. As shown in FIG. 4, the drive mechanism 54 is located beneath the floor 24 of the casket compartment 16 of the funeral vehicle 12 such that the drive shaft 76 is generally aligned with the track slot 52 formed in the floor 24. The slide 74 is configured to be moved linearly along the length of the drive mechanism 54 between the first end 80 and the second end 82 by a motor 84. In particular, the motor 84 is operatively connected to the drive shaft 76 such that clockwise rotational movement of the drive shaft 76 by the motor 84 advances the slide 74 in a first direction and counterclockwise movement of the drive shaft 76 by the motor 84 advance the slide 74 in an opposite, second direction. The slide 74 includes the drive member to which the sled 20 is attached, as described above. In that regard, the drive member extends from the slide 74 and through the track slot 52 to support the sled 20 over the floor 24 of the casket compartment 16. Although a linear slide drive is shown, the drive mechanism 54 may comprise any suitable drive for imparting linear motion to the sled 20 and the urn support 22 of the urn carrier 10, such as ball screw drives, belt drives, chain drives, linear actuators, hydraulic or pneumatic drives, or magnetic drives, for example.

In addition to linear movement, in one embodiment, the drive mechanism 54 may also be configured to impart rotational movement to the sled 20 and the urn support 22 of the urn carrier 10. To achieve this, the drive member may be rotatable relative to the slide 74 of the drive mechanism 54. In particular, the drive member may be operable to rotate about an axis of rotation to thereby rotate the sled 20 relative to the slide 74 of the drive mechanism 54. In one embodiment, the slide 74 may include a motor that is configured to rotate the drive member to selectively rotate the sled 20 and the urn support 22. In another embodiment, the rotational motion of the drive member may be generated mechanically through the movement of the slide 74 along the drive shaft 76 within the drive mechanism 54. This mechanical transformation may employ a cam and follower arrangement, exemplifying a method where the rotational movement is induced as a consequence of the slide 74 interacting with the cam profile on the drive shaft 76. In an exemplary embodiment, one or more of the guide bars 78 may include gear teeth that are configured to engage a gear on the drive member. Thus, as the slide 74 moves in the first direction along the drive shaft 76, the geared engagement rotates the drive member and thus the sled 20 in a first direction (i.e., clockwise). As the slide 74 moves in the opposite direction along the drive shaft 76, the geared engagement rotates the drive member and thus the sled 20 in the opposite direction (i.e., counterclockwise). To that end, the drive mechanism 54 is configured to rotate the sled 20 and the urn support 22 as they travel along the length of the drive mechanism 54, and between at least the stowed position and the transport or the ceremonial position.

Referring now to FIGS. 5A-5D, movement of the sled 20 and the urn support 22 from the stowed position to the transport and the ceremonial position will now be described in accordance with one embodiment of the present invention. While movement and positioning of the sled 20 may be described, it will be understood that movement and positioning of the sled 20 corresponds to movement and positioning of the urn support 22, which is removably attached to the sled 20. FIG. 5A shows the sled 20 in the stowed position with the urn support 22 being attached to the sled 20. When in the stowed position, the sled 20 is located in the front region 26 of the casket compartment 16, and in particular the cargo space 36. The sled 20 and the urn support 22 may be positioned adjacent to the partition 34 that separates at least the driver compartment of the funeral vehicle 12 from the casket compartment 16, as shown in FIG. 1, for example. In one embodiment, the sled 20 and the urn support 22 may be configured to nest into the partition 34 or a storage compartment adjacent the partition 34. In another embodiment, the sled 20 and the urn support 22 may be concealed by the partition 34 or otherwise incorporated into the partition 34. In either case, when in the stowed position, the longitudinal axis A2 of the urn support 22 is substantially perpendicular to the longitudinal axis A1 of the casket compartment 16. Stated another way, when in the stowed position, the longitudinal axis A2 of the urn support 22 is substantially perpendicular to the track slot 52. As a result, additional items may be easily stored in the cargo space 36 between the urn support 22 and the casket 18, for example. If used, the removable cover may be installed over the urn support 22 when in the stowed position, as described above.

In one example of how to use the urn carrier 10 for a cremation service, the cover may be removed (if used) and the drive mechanism 54 operated to move the sled 20 and the urn support 22 from the stowed position at the front region 26 of the casket compartment 16 to the rear region 28 of the casket compartment 16. The cover may be lowered back down and remain in the cargo space 36 once the sled 20 and the urn support 22 have been moved. Regardless, the drive mechanism 54 is operated to move the sled 20 and the urn support 22 from the front region 26 to the rear region 28, as shown in FIG. 5B. As the sled 20 and the urn support 22 travel along the track slot 52, the drive mechanism 54 may be configured to rotate the sled 20 and the urn support 22, as shown in FIG. 5B. The drive mechanism 54 may be configured to rotate the sled 20 and the urn support 22 360° about the rotational axis defined by the drive member. However, in the embodiment shown, the drive mechanism 54 is configured to rotate the sled 20 and the urn support 22 about 90° about the rotational axis as the sled 20 and the urn support 22 are moved from the front region 26 of the casket compartment 16 to the rear region 28. In that regard, rotation of the sled 20 and the urn support 22 may be progressive as the sled 20 and the urn support 22 are moved along the length of the casket compartment 16. Alternatively, the drive mechanism 54 may pause longitudinal movement of the sled 20 and the urn support 22 halfway along the track slot 52 to complete a 90° rotation of the sled 20 and the urn support 22 before resuming longitudinal movement of the sled 20 and the urn support 22 towards the rear region 28 of the casket compartment 16.

The drive mechanism 54 is configured to advance the sled 20 and the urn support 22 from the stowed position, shown in FIG. 5A, to an intermediate transport position where the sled 20 and the urn support 22 may be located aft of the partition 34. By aft, it is meant in a direction toward the load door 30 and rear of the partition of the funeral vehicle 12. Thus, when in the intermediate transport position, the sled 20 and the urn support 22 may be moved away from the partition 34 to a position closer to the load door 30 of the funeral vehicle 12. The sled 20 and the urn support 22 may be located in either the cargo space 36 or the casket compartment 16 of the funeral vehicle 12 when in the transport position. The sled 20 and the urn support 22 may not rotate when moved from the stowed position to the transport position, and movement may only be longitudinal. The sled 20 and the urn support 22 may remain in the transport position while the funeral vehicle 12 transports the urn 14, for example. To that end, the sled 20 may be locked in the intermediate transport position during transportation to prevent any inadvertent movement of the sled 20 and the urn support 22.

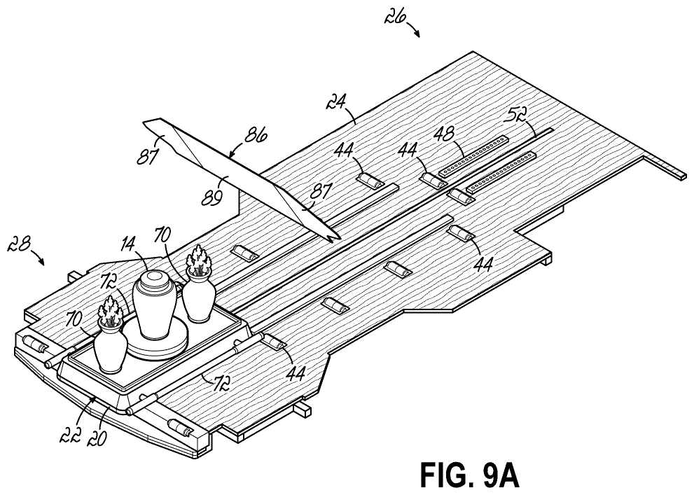

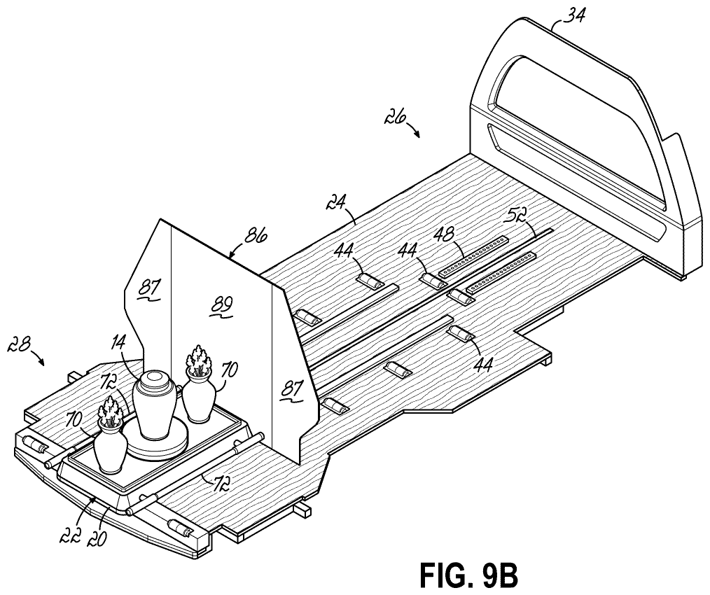

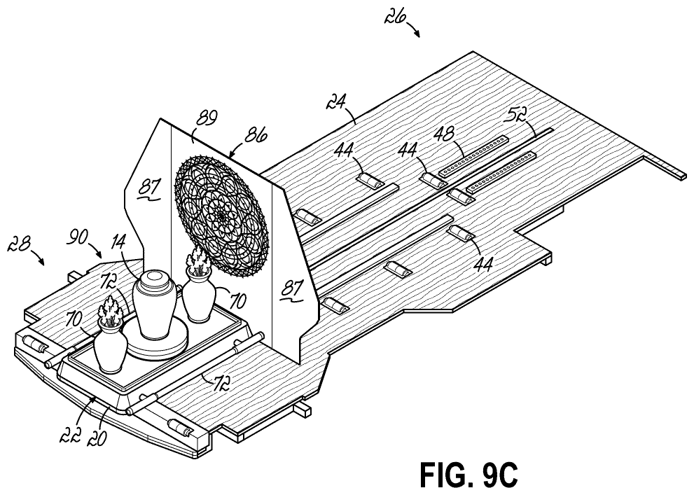

The drive mechanism 54 is further configured to advance the sled 20 and the urn support 22 from the stowed position or the intermediate transport position to a ceremonial position (e.g., FIG. 9B). When in the ceremonial position, the sled 20 and the urn support 22 are located in the rear region 28 of the casket compartment 16 adjacent the load door 30 of the funeral vehicle 12. For example, the sled 20 and the urn support 22 may be spaced a distance of 10 inches or less from the load door 30 of the funeral vehicle 12 when in the ceremonial position. Furthermore, when in the ceremonial position, the sled 20 and the urn support 22 have been rotated 90° from the stowed position such that the longitudinal axis A2 of the urn support 22 is substantially parallel to the longitudinal axis A1 of the casket compartment 16. Stated another way, when in the ceremonial position, the longitudinal axis A2 of the urn support 22 is substantially parallel to the track slot 52. The urn 14 and other decorative features may be installed to the urn support 22 when in the stowed, the transport, or the ceremonial position.

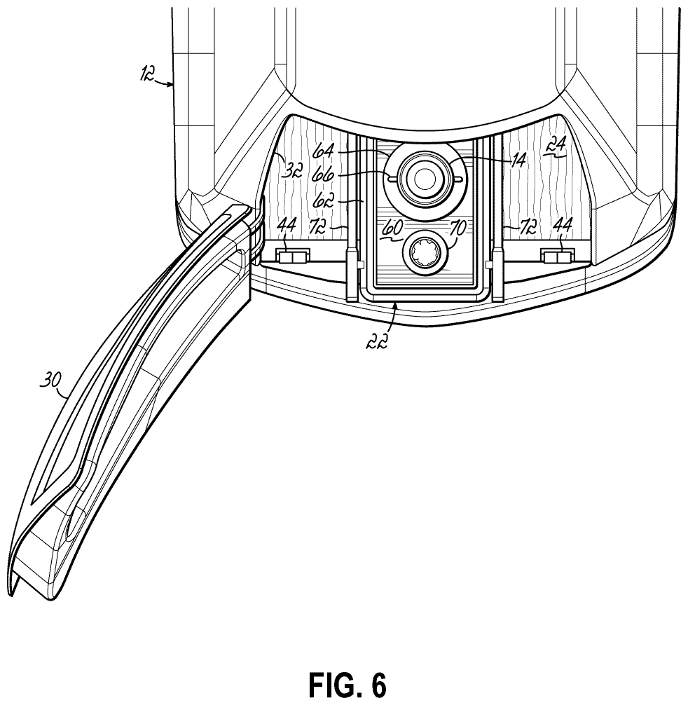

In one embodiment, the drive mechanism 54 of the urn carrier 10 may be further configured to move the sled 20 and the urn support 22 from the ceremonial position to an extended position, as shown in FIGS. 5C and 5D. In that regard, once the load door 30 of the funeral vehicle 12 is opened, the drive mechanism 54 may be operated to advance the sled 20 towards the load door opening 32 until a portion of the urn support 22 extends or protrudes from the load door opening 32 of the funeral vehicle 12. In this embodiment, unless the load door 30 is open, the drive mechanism 54 may be prevented from advancing the sled 20 and the urn support 22 from the ceremonial position to the extended position. Movement of the sled 20 and the urn support 22 from the ceremonial position to the extended position may include moving the sled 20 and the urn support 22 a distance of 36 inches or less, for example. In alternative embodiment, the sled 20 and urn support 22 may be manually moved from the ceremonial position to the extended position (even should movement between the other positions be driven). Thus, the sled 20 and the urn support 22 generally remain located in the rear region 28 of the casket compartment 16 when in the extended position. Further, the sled 20 and the urn support 22 may not rotate when moved from the ceremonial position to the extended position, and movement may only be longitudinal. As shown in FIG. 6, when in the extended position, approximately 50% or less of the total length of the urn support 22 may extend from the load door opening 32 of the funeral vehicle 12. In the embodiment shown, approximately 30% or less of the total length of the urn support 22 may extend from the load door opening 32 of the funeral vehicle 12.

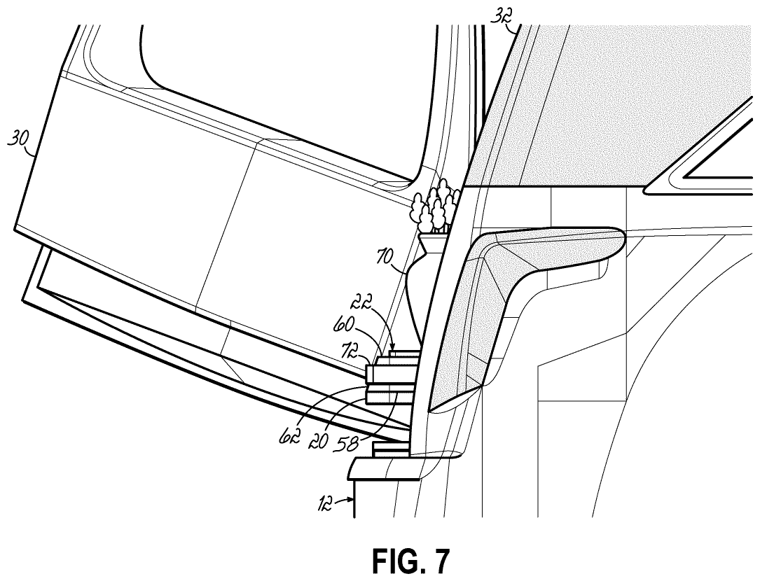

With reference to FIGS. 6 and 7, when in the extended position, a portion of the urn support 22 extends from the casket compartment 16 for easy handling by pallbearers. Specifically, pallbearers do not need to reach into the casket compartment 16 to drag and remove the urn support 22 therefrom. Instead, the urn support 22 extends from the load door opening 32, presenting the handles 72 for the pallbearers to easily lift the urn support 22 away from the sled 20 of the urn carrier 10. Similarly, once the cremation ceremony has concluded, for example, the urn support 22 may be easily placed back onto the sled 20 while in the extended position. The sled 20 and un support 22 may then be moved back to the ceremonial position or directly to the transport position, and the load door 30 closed. The sled 20 and urn support 22 may later be returned to their stowed position, where the urn support 22 may be unloaded and covered with the cover. This way, the funeral vehicle 12 may be used for a casketed funeral.

In another embodiment, movement of the sled 20 and the urn support 22 between the stowed, transport, ceremonial, and extended positions by the drive mechanism 54 may only be linear. That is, the sled 20 and the urn support 22 may not rotate when moved between stowed, transport, ceremonial, and extended positions, as described above, and movement may only be longitudinal. In that regard, the sled 20 and the urn support 22 may be arranged as shown in FIG. 5A, with the longitudinal axis A2 of the urn support 22 being substantially perpendicular to the longitudinal axis A1 of the casket compartment 16. During movement of the sled 20 and the urn support 22 between each of the stowed, transport, ceremonial, and extended positions, the longitudinal axis A2 of the urn support 22 remains substantially perpendicular to the longitudinal axis A1 of the casket compartment 16.

Movement of the urn carrier 10, and in particular the sled 20 and the urn support 22 between the stowed position, the transport position, the ceremonial position, and the extended position may be selectively controlled from the driver compartment of the funeral vehicle 12 and/or from the casket compartment 16 of the funeral vehicle 12. For example, at least one controller may be located on the funeral vehicle 12 near the load door opening 32 so that movement of the urn carrier 10 may be controlled from the rear of the funeral vehicle 12. Additionally, or alternatively, a hand-held controller may be used to remotely control operation of the urn carrier 10. In one embodiment, movement of the sled 20 and the urn support 22 from the transport position to the ceremonial position, or from the ceremonial position to the extended position, may be triggered by opening of the load door 30. Similarly, initiating the closing of the load door 30 may cause the sled 20 and the urn support 22 to be moved from the extended position back to the ceremonial or transport position. It will be understood that other control and logic schemes for selectively controlling operation of the urn carrier 10 are possible. To this end, the sled 20 and the urn support 22 may be moved directly between any one of the stowed, the transport, the ceremonial, or the extended positions.

The funeral vehicle 12 may also be equipped with various control devices and safety mechanisms to prevent damage to the vehicle 12 and its components, such as the drive mechanism 54 and the urn carrier 10. These safeguards serve to avoid potential injuries that could result from various failure modes, unintended operation by an untrained person, or other operational scenarios.

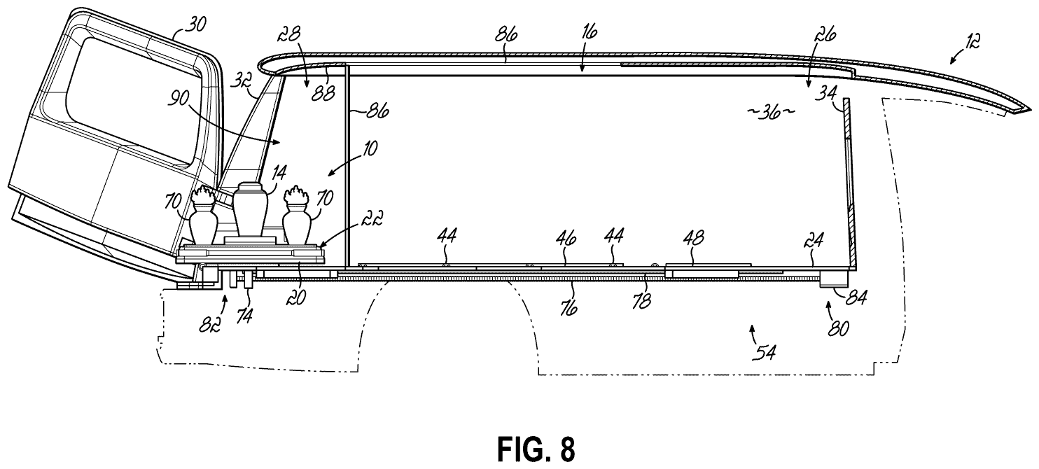

Turning now with reference to FIGS. 8-9C, the funeral vehicle 12 may further include a movable partition 86 that is movable between at least a retracted position and a deployed position to close out a portion of the casket compartment 16. That is, the partition 86 is generally configured to separate the front region 26 of the casket compartment 16 from the rear region 28 of the casket compartment 16 when in the deployed position. The partition 86 may be movably supported from a part of the funeral vehicle 12 (e.g., side wall(s), floor 24, sled 20, headliner). For example, the partition 86 may be attached to or incorporated in a headliner 88 of the funeral vehicle 12 so as to be moveable about a hinge joint. In one embodiment, the partition 86 may be a removable piece and only temporarily installed to the headliner 88 when in use. In another embodiment, the partition 86 may be integrated with the headliner 88 so as to remain attached to the headliner 88. The partition 86 is configured to rotate about the hinge joint between the retracted position, where the partition 86 lies generally flush against the headliner 88 of the funeral vehicle 12 (or recessed into the headliner 88), and the deployed position, where the partition 86 extends generally straight down (i.e., generally perpendicular) to the headliner 88, as shown in FIG. 8. The partition 86 may be in or moved to the retracted position such as for a casketed funeral service. When in the retracted position, and from the viewpoint of pallbearers, family members, and others that are paying respects at the funeral vehicle 12, the partition 86 is flush against the headliner 88 to present a purpose-built, more intimate display space, that provides a dignified way to present the casket 18. Movement of the partition 86 between the retracted and the deployed position may be manual or driven. When in the retracted or the deployed position, the partition 86 may be secured in place relative to the funeral vehicle 12 to prevent unintentional movement of the partition 86 while the funeral vehicle 12 is moving, for example. Additionally, or alternatively, the partition 86 may incorporate features configured to prevent unintentional movement of the partition 86 that may occur due to air pressure changes and/or wind movement in the funeral vehicle 12.

As shown in FIG. 8, when in the deployed position, the partition 86 defines a display space 90 that transforms the appearance of the casket compartment 16 when viewed from the load door opening 32. That is, from the viewpoint of pallbearers, family members, and others that are paying respects at the rear of the funeral vehicle 12, the partition 86 transforms the seemingly cavernous interior of the casket compartment 16 into a purpose-built, more intimate display space 90, that provides a dignified way to present the urn 14. When in the deployed position, a person looking into the casket compartment 16 from the load door opening 32 will be mostly (or entirely) prevented from seeing the front region 26 of the casket compartment 16 and the remainder of the interior (such as the driver compartment) of the funeral vehicle 12 by the partition 86. In that regard, the viewable display space 90 includes only a portion of the casket compartment 16, such as only the rear region 28 of the casket compartment 16 (i.e., 50% of the casket compartment 16). In one embodiment, the display space 90 may comprise only a portion of the rear region 28 of the casket compartment 16 (i.e., less than 50% of the casket compartment 16).

The partition 86 may be formed as a single-piece panel that defines a continuous, unbroken surface. In an alternative embodiment, the partition 86 may comprise several panels connected by hinges or flexible joints. When unfolded, these panels combine to form a larger flat surface, which becomes the partition 86. For example, and with reference to FIGS. 9A-9C, the partition 86 may be segmented into opposite side panels 87 and a central panel 89. The opposite side panels 87 may be configured to fold about respective hinge joints relative to the central panel 89 of the partition 86. In particular, the side panels 87 may be configured to fold inward and rest against the central panel 89 when the partition 86 is in the retracted position. Specifically, when retracted, the side panels 87 may be folded in and arranged between the headliner 88 and the central panel 89 of the partition 86. As the partition 86 is moved from the retracted position to the deployed position, the side panels 87 may unfold outward from either side of the central panel 89 to eventually align with the central panel 89 to form a larger flat surface, completing the partition 86. To that end, the panels 87, 89 are movable between a folded configuration when the partition 86 is in the stowed position and an unfolded configuration when the partition 86 is in the deployed position. The movement of the partition 86, including the central panel 89 and side panels 87, between the retracted and deployed positions may be accomplished using any device that allows for manual or powered movement of those parts, such as one or more hydraulic actuators, electric motors, pneumatic systems, or mechanical linkages, for example.

The partition 86 may be deployed (i.e., located in the deployed position) whenever the sled 20 and the urn support 22 are in the ceremonial position or the extended position. That is, the sled 20 and the urn support 22 may be located aft of the deployed partition 86 when in the ceremonial or extended position. The sled 20 and the urn support 22 may be located fore of the deployed partition 86 when in the transport or stowed position. The partition 86 may be retracted (i.e., located in the retracted position) when the sled 20 and the urn support 22 are in the stowed position. To that end, movement of the sled 20 of the urn carrier 10 may cause or trigger movement of the partition 86. For example, movement of the sled 20 from the stowed or the transport position to the ceremonial or the extended position may cause movement of the partition 86 from the retracted position to the deployed position. Likewise, movement of the sled 20 from the ceremonial or the extended position to the transport or stowed position may cause movement of the partition 86 from the deployed position to the retracted position. Additionally, or alternatively, movement of the partition 86 may be separately controlled.

The partition 86 may include one or more decorative elements, such as scenes or religious symbols, to enhance the appearance of the display space 90. For example, the partition 86 may have the appearance of a stained-glass window. In that regard, the partition 86 may be formed of wood, plastic, or fabric. The partition 86 may be integrated into the headliner 88 of the funeral vehicle 12 such that when in the retracted position, the partition 86 provides a decorative feature as part of the headliner 88. When the partition 86 is in the retracted position, the headliner 88 may have a seamless appearance.

In an alternative embodiment of the present invention, the urn carrier 10 may include a non-driven movement element that is configured to permit manual movement of the urn support 22 along the length of the casket compartment 16. For example, the movement element may comprise a slide track, pulley system, chain and sprocket system, rail system, or other suitable manual movement system. To that end, all above-described driven movements of the urn carrier 10, and in particular the urn support 22 and sled 20, may be carried out manually. Further, the non-drive movement element may serve as a backup operating mode for a driven movement element to enable use in the event of an electrical failure or other problems with the driven movement element.

Furthermore, the urn carrier 10 may not include a sled 20. Rather, the urn support 22 may be directly, albeit removably, attached to the movement element. For example, the urn carrier 10 may include a rod or other support member that extends through the track slot 52 in the floor 24 to which the urn support 22 may be removably attached. The support member may permit manual rotation of the urn support 22. However, in another embodiment, the urn support 22 may not rotate. That is, the rotational position of the urn support 22 remains unchanged as the urn support 22 is moved from the stowed position to the ceremonial position. For example, the longitudinal axis A2 of the urn support 22 may be substantially parallel (or perpendicular) to the longitudinal axis A1 of the casket compartment 16 when in the stowed position, transport position, ceremonial position, and the extended position. In yet another embodiment, the urn support 22 may not extend beyond from the load door opening 32 of the funeral vehicle 12 in the extended position. For example, the ceremonial position of the urn support 22 may also be the extended position.

While the present invention has been illustrated by the description of various embodiments and while these embodiments have been described in some detail, it is not the intention of the Applicant to restrict or in any way limit the scope of the invention to such detail. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1. An urn carrier for a funeral vehicle having a casket compartment, the urn carrier comprising:
an urn support configured to receive at least one urn; and
a movement element configured to removably receive the urn support, the movement element being configured to move the urn support along a length of the casket compartment.

2. The urn carrier of claim 1, wherein the urn support is movable between at least a stowed position and a ceremonial position.

3. The urn carrier of claim 2, wherein the urn support is moveable between the stowed position, a transport position, a ceremonial position, and an extended position.

4. The urn carrier of claim 3, wherein when the urn carrier is in the transport position, the urn support is located in a front region of the funeral vehicle.

5. The urn carrier of claim 3, wherein when the urn support is in the extended position, a portion of the urn support extends from a load door opening of the funeral vehicle.

6. The urn carrier of claim 2, wherein when the urn support is in the stowed position, the funeral vehicle is configured to receive a casket within the casket compartment of the funeral vehicle.

7. The urn carrier of claim 2, wherein when the urn support is in the stowed position, the urn support is located in the front region of the casket compartment and wherein when the urn support is in the ceremonial position, the urn support is located in the rear region of the casket compartment.

8. The urn carrier of claim 2, wherein when the urn carrier is in the ceremonial position, the urn support is located adjacent a load door of the funeral vehicle.

9. The urn carrier of claim 1, wherein the urn carrier further comprises a sled operatively attached to the movement element, the sled being configured to removably receive the urn support.

10. The urn carrier of claim 1, wherein the movement element comprises at least one drive mechanism.

11. The urn carrier of claim 10, wherein the at least one drive mechanism includes a linear drive having a drive member, the urn support being attachable to the drive member.

12. The urn carrier of claim 11, wherein the linear drive is located beneath a floor of the casket compartment of the funeral vehicle.

13. The urn carrier of claim 12, wherein the floor of the casket compartment includes a track slot through which the drive member is configured to extend and along which the drive member is configured to travel.

14. The urn carrier of claim 13, wherein the track slot extends from the front region of the casket compartment to the rear region of the casket compartment.

15. The urn carrier of claim 10, wherein the at least one drive mechanism is configured to rotate the urn support as the urn support is moved between at least the stowed position and the ceremonial position.

16. A funeral vehicle including the urn carrier of claim 1.

17. The funeral vehicle of claim 16, further comprising a movable partition movable between a retracted position and a deployed position.

18. The funeral vehicle of claim 17, wherein the movable partition separates the front region of the casket compartment from the rear region of the casket compartment when in the deployed position.

19. The funeral vehicle of claim 17, wherein movement of the urn support is coordinated with movement of the movable partition.

20. The funeral vehicle of claim 17, wherein the funeral vehicle includes a headliner, and wherein the movable partition is attached to the headliner of the funeral vehicle.

21. The funeral vehicle of claim 20, wherein the movable partition forms part of or is adjacent to the headliner when in the retracted position.

22. The funeral vehicle of claim 17, wherein the movable partition comprises a plurality of panels that are movable between a folded configuration and an unfolded configuration, and wherein the plurality of panels is in the folded configuration when the movable partition is in the retracted position and the plurality of panels is in the unfolded configuration when the movable partition is in the deployed position.

23. The funeral vehicle of claim 22, wherein movement of the plurality of panels is coordinated with movement of the movable partition.

24. The funeral vehicle of claim 16, wherein the funeral vehicle further comprises a storage compartment located in a cargo space of the funeral vehicle, and wherein the urn support is configured to be located in the storage compartment when the urn carrier is not in use.

25. A method of handling an urn in a funeral vehicle having a casket compartment, comprising:
providing an urn carrier, comprising:
an urn support configured to receive at least one urn; and
a movement element configured to removably receive the urn support, the movement element being configured to move the urn support along a length of the casket compartment; and
moving the urn support from a first position within the casket compartment to a second position within the casket compartment.

26. The method of claim 25, wherein moving the urn carrier from the first position to the second position includes driving the movement of the urn carrier with at least one drive mechanism.

27. The method of claim 25, further comprising rotating the urn support in the movement between the first position and the second position.

28. The method of claim 25, wherein the casket compartment of the funeral vehicle includes a movable partition, and wherein the method further comprises:
moving the movable partition from a retracted position to a deployed position in the movement between the first position and the second position.

29. The method of claim 28, further comprising:
moving the urn support from the second position the first position; and
moving the movable partition from the deployed position to the retracted position in the movement between the first position and the second position.

30. The method of claim 25, wherein the first position is a stowed position, or a transport position and the second position is a ceremonial position.
